(19) United States
(12) Patent Application Publication
(10) Pub. No.: US 2026/0244184 A1
(43) Pub. Date: Aug. 20, 2026

(54) DISTRIBUTION AMOUNT DETERMINATION DEVICE, NUMERICAL CONTROL DEVICE, AND DISTRIBUTION AMOUNT DETERMINATION SYSTEM

(71) Applicant: FANUC CORPORATION, Minamitsuru-gun, Yamanashi (JP)

(72) Inventor: Shunsuke KARAKI, Minamitsuru-gun, Yamanashi (JP)

(21) Appl. No.: 19/159,820

(22) PCT Filed: Apr. 7, 2023
(86) PCT No.: PCT/JP2023/014371

§ 371 Date: Aug. 26, 2025

(51) Int. Cl. G05B 19/404

(52) U.S. Cl. CPC G05B 19/404; G05B 2219/49206

(57) ABSTRACT

A distribution amount determination device for determining the distribution amount of the thermal displacement correction amount of a machine tool includes: an emphasized machining information acquisition unit that acquires information including information relating to surface quality in machining, information relating to dimensional accuracy in machining, and/or a machining program analysis result; and a condition storage unit that stores a condition for emphasizing the surface quality, a condition for emphasizing the dimensional accuracy, and/or a condition for machining program analysis result and a distribution amount when at least one condition is satisfied. The device also includes a distribution amount determination unit that determines the distribution amount based on the information including the at least one item acquired by the emphasized machining information acquisition unit and at least one condition and the distribution amount when this condition is satisfied which are stored in the condition storage unit.

### TECHNICAL FIELD

The present disclosure relates to a distribution amount determination device, a numerical control device, and a distribution amount determination system, and particularly, to a distribution amount determination device, a numerical control device, and a distribution amount determination system that determine distribution amounts of a thermal displacement correction amount of a machine tool.

### BACKGROUND ART

A thermal displacement correction method for a machine tool is disclosed in, for example, Patent Documents 1, 2, and 3.

Patent Document 1 discloses a thermal displacement correction method for a numerically controlled machine tool suitable for a case where smooth, curved surface machining is required for a die or the like. Specifically, in the numerically controlled machine tool disclosed in Patent Document 1, a target position Zpsn in the z-axis direction provided from a calculation unit that calculates the target position at every sampling cycle in a numerical control device NC is added to a thermal displacement correction amount Cn calculated by the thermal displacement correction method of the invention in an adding unit AD, the resultant value is provided to a servo control unit, and a Z-axis driving motor is driven via a servo amplifier. A temperature detection unit is provided which performs A/D conversion of analog signals received from temperature sensors S1 and S2 into digital amounts Tn. Furthermore, a calculation unit is provided which calculates a target value P of the thermal displacement correction amount in the Z-axis direction, and the target value P is provided to a thermal displacement correction filter unit. An output from the thermal displacement correction filter unit is the thermal displacement correction amount Cn, and is represented as follows: Cn=P+(Cn−1−P)·EXP (−t/T).

Patent Document 2 discloses a thermal displacement correction method for a machine tool that substantially shortens a correction interval to reduce a correction error, without increasing a load on an arithmetic circuit. Specifically, in the thermal displacement correction method disclosed in Patent Document 2 that is a thermal displacement correction method of intermittently repeating correction based on a machine temperature at predetermined intervals, intermediate correction is performed between the correction intervals. To perform the intermediate correction, a difference between thermal displacement correction amounts of a portion to be corrected that are calculated from the previous temperature and the current temperature is divided by a preset correction interval to calculate a compensation speed. An intermediate correction iteration count and a correction interval are obtained on the basis of the compensation speed. The intermediate correction amounts for the correction iteration count are calculated using the compensation speed and a correction coefficient. As the correction coefficient, a value is used which is inversely proportional to the correction iteration count and progresses according to the correction iteration count. An intermediate correction amount in the N-th correction is obtained from the product of the correction coefficient, the compensation speed, and N, and the portion to be corrected is controlled according to the intermediate correction amount.

Patent Document 3 discloses a thermal displacement correction method for a machine tool in which a thermal correction coefficient can be easily changed on an NC machining program to thereby allow for an optimal thermal displacement applicable corresponding to a wide rotation speed region. Specifically, according to the thermal displacement correction method disclosed in Patent Document 3, a variable range for the spindle rotation speed is divided into a plurality of rotation speed regions, and thermal displacement correction coefficients that are different for each rotation speed region are preset as system parameters of the machine. A function command to change the value of the thermal displacement correction coefficient for adjustment of the thermal displacement correction coefficient for each of the rotation speed regions is created as a user macro, and a user macro call command is incorporated into a machining program. In the course of executing the machining program, the user macro is called and executed as necessary, thereby changing the thermal displacement correction coefficient to an appropriate value.

### CITATION LIST

### Patent Document

Patent Document 1: Japanese Unexamined Patent Application, Publication No. 2010-99761
Patent Document 2: Japanese Unexamined Patent Application, Publication No. H10-156663
Patent Document 3: Japanese Unexamined Patent Application, Publication No. 2002-239872

### DISCLOSURE OF THE INVENTION

### Problems to be Solved by the Invention

In a case where the thermal displacement is predicted from the temperature of the machine tool to perform the thermal displacement correction, a tool tip point abruptly moves when the thermal displacement correction amount is applied as it is, which may cause an adverse effect on the machining, such as generation of machining streaks or the like. To reduce the adverse effect on the machining, it is conceivable that the thermal displacement correction amount is not applied at once, but the thermal displacement correction amount is divided, and the correction is performed for each distribution amount of the thermal displacement correction amount, obtained by the division.

When the distribution amount is small, the generation of the machining streaks or the like can be prevented and the surface quality can be improved, whereas when the distribution amount is large, a difference between the target correction value and the output correction amount can be reduced, which enables correction with higher accuracy, leading to enhancement of the dimensional accuracy. As such, it is not necessarily easy to determine the distribution amount. In addition, it is time-consuming for a user to determine whether machining is performed with emphasis on surface quality or with emphasis on dimensional accuracy from a machining procedure manual or the like and set the distribution amount for each machining. When the machining program is executing the rapid traverse, the machining is not performed, so that the distribution amount can be increased.

Therefore, it is desired to provide a distribution amount determination device, a numerical control device, and a distribution amount determination system that can easily determine distribution amounts of a thermal displacement correction amount of a machine tool without inconveniencing a user.

### Means for Solving the Problems

A first representative aspect of the present disclosure provides a distribution amount determination device that determines a distribution amount of a thermal displacement correction amount of a machine tool, the distribution amount determination device including: an in-machining emphasis information acquisition unit that acquires information including at least one of information relating to surface quality in machining, information relating to dimensional accuracy in machining, or a machining program analysis result, a condition storage unit that stores at least one condition of a condition for emphasis on surface quality, a condition for emphasis on dimensional accuracy, or a condition for the machining program analysis result, and stores a distribution amount when the at least one condition is satisfied, and a distribution amount determination unit that determines a distribution amount of the thermal displacement correction amount based on the information including the at least one and acquired by the in-machining emphasis information acquisition unit, and based on the at least one condition and the distribution amount when the condition is satisfied, the at least one condition and the distribution amount being stored in the condition storage unit.

A second representative aspect of the present disclosure provides a numerical control device including: the above-described distribution amount determination device, and a correction amount distribution unit that distributes a thermal displacement correction amount of a machine tool based on the distribution amount determined by the distribution amount determination unit of the distribution amount determination device.

A third representative aspect of the present disclosure provides a distribution amount determination system for a thermal displacement correction amount, including: the above-described numerical control device, and a thermal displacement correction device that generates a thermal displacement correction amount of a machine tool based on temperature data regarding the machine tool, and outputs the thermal displacement correction amount to the numerical control device.

### BRIEF DESCRIPTION OF THE DRAWINGS

FIG. 1 is a configuration diagram showing a configuration example of a distribution amount determination system for a thermal displacement correction amount, including a numerical control device of one embodiment of the present invention.

FIG. 2 is a diagram showing thermal displacement of a tool tip point predicted from a temperature change of a machine tool and a thermal displacement correction amount for correcting an amount of movement due to the thermal displacement.

FIG. 3 is a graph showing a relationship between a temperature of the machine tool and a thermal displacement correction amount updated at a regular cycle.

FIG. 4 is a graph showing operations for dividing the thermal displacement correction amount into each distribution amount to increase the thermal displacement correction amount by each thermal displacement distribution amount.

FIG. 5 is a diagram for describing a tolerance.

FIG. 6 is a diagram showing a flow in which a distribution amount determination unit determines a distribution amount on the basis of a machining program analysis result.

FIG. 7 is a diagram showing a flow in which the distribution amount determination unit determines a distribution amount on the basis of information relating to a speed during interpolation.

FIG. 8 is a diagram showing a flow in which the distribution amount determination unit determines a distribution amount on the basis of information relating to program command curving.

FIG. 9 is a flowchart showing the operation of the numerical control device.

### PREFERRED MODE FOR CARRYING OUT THE INVENTION

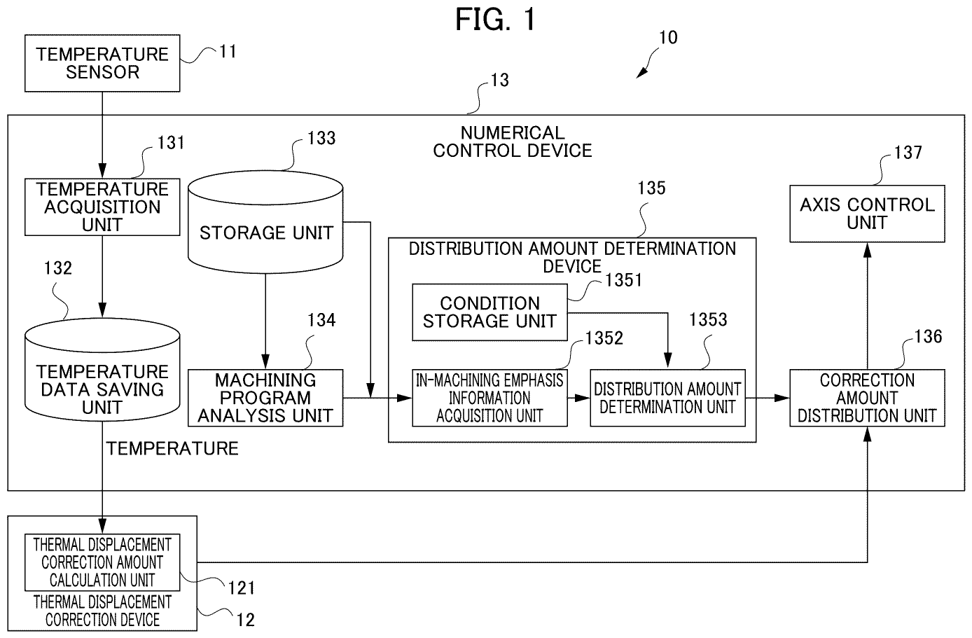

Embodiments of the present disclosure will be described below in detail with reference to the drawings. FIG. 1 is a configuration diagram showing a configuration example of a distribution amount determination system for a thermal displacement correction amount, including a numerical control device of one embodiment of the present invention.

As shown in FIG. 1, a distribution amount determination system 10 for a thermal displacement correction amount includes a temperature sensor 11, a thermal displacement correction device 12, and a numerical control device 3. The thermal displacement correction device 12 may be included in the numerical control device 13.

The temperature sensor 11 is attached to a machine tool, and temperature data regarding a temperature detected by the temperature sensor 11 is saved in the numerical control device 13. The temperature sensor 11 is attached to a portion that affects the thermal displacement of a tool tip point, such as the periphery of a spindle or the periphery of a motor. The number of temperature sensors 11 may be plural. The temperature data output from the numerical control device 13 is output to the thermal displacement correction device 12.

The thermal displacement correction device 12 generates a correction amount for thermal displacement (hereinafter, referred to as a thermal displacement correction amount) for correcting thermal displacement of the tool tip point on the basis of the temperature data, and inputs the thermal displacement correction amount to the numerical control device 13.

The numerical control device 13 determines distribution amounts of the thermal displacement correction amount, and divides the thermal displacement correction amount input from the thermal displacement correction device 12 into each distribution amount to control an axis in the machine tool for each control axis on the basis of the distribution amount (hereinafter, referred to as a thermal displacement distribution amount) of the thermal displacement correction amount, obtained by the division.

The thermal displacement correction device 12 will be further described below with reference to FIGS. 1, 2, and 3.

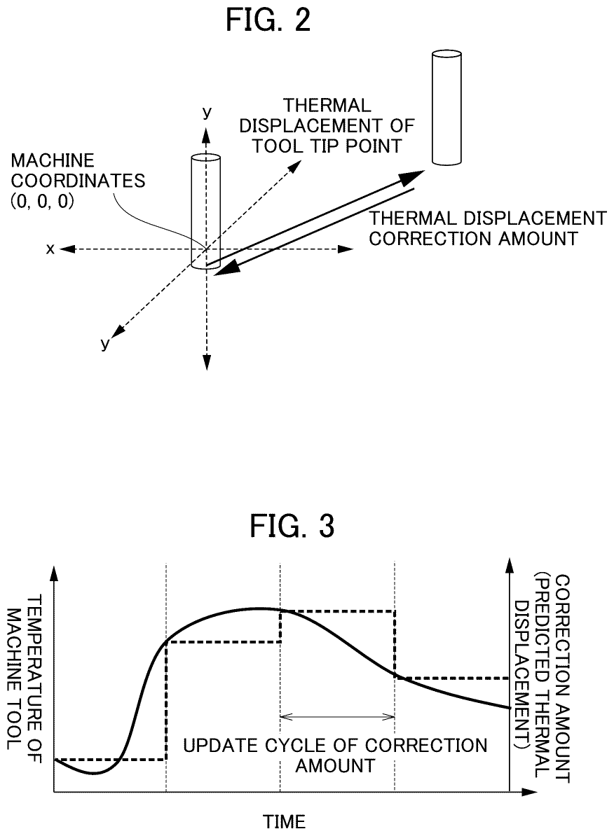

As shown in FIG. 1, the thermal displacement correction device 12 includes a thermal displacement correction amount calculation unit 121, and the thermal displacement correction amount calculation unit 121 calculates a thermal displacement correction amount from the temperature data regarding the machine tool acquired from the numerical control device 13. For example, when the tool tip point shown in FIG. 2 is predicted to move from machine coordinates (0, 0, 0) due to thermal displacement caused by a temperature change of the machine tool, the thermal displacement correction amount calculation unit 121 calculates a thermal displacement correction amount corresponding to an amount of movement of the tool tip point due to the thermal displacement to output the thermal displacement correction amount to the numerical control device 13.

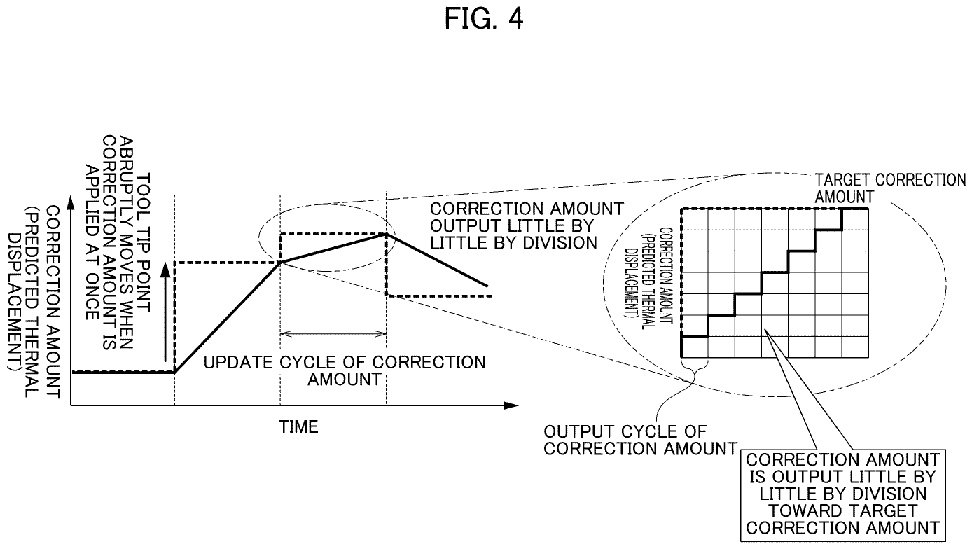

The thermal displacement correction amount calculation unit 121 updates the thermal displacement correction amount at a regular cycle of several seconds to several tens of seconds, and outputs the thermal displacement correction amount on the order of msec. FIG. 3 is a graph showing a relationship between a temperature of the machine tool and the thermal displacement correction amount updated at a regular cycle. In FIG. 3, a solid line indicates a temperature of the machine tool, and a dashed line indicates a thermal displacement correction amount (predicted thermal displacement). The correction amount shown in FIG. 3 and FIG. 4 described later represents a thermal displacement correction amount.

Next, the numerical control device 13 will be further described with reference to FIGS. 1 and 4.

### (Numerical Control Device 13)

As shown in FIG. 1, the numerical control device 13 includes a temperature acquisition unit 131, a temperature data saving unit 132, a storage unit 133, a machining program analysis unit 134, a distribution amount determination device 135, a correction amount distribution unit 136, and an axis control unit 137. The axis control unit 137 may be provided outside the numerical control device 13.

The temperature acquisition unit 131 acquires the temperature data detected from the temperature sensor 11, and saves the temperature data in the temperature data saving unit 132. One or both of the temperature acquisition unit 131 and the temperature data saving unit 132 may be provided outside the numerical control device 13. Alternatively, the temperature acquisition unit 131 and the temperature data saving unit 132 may be provided in the thermal displacement correction device 12.

The storage unit 133, the machining program analysis unit 134, the distribution amount determination device 135, the correction amount distribution unit 136, and the axis control unit 137 divide the thermal displacement correction amount output from the thermal displacement correction device 12 into each distribution amount to control the axis in the machine tool on the basis of the thermal displacement distribution amount obtained by the division.

The thermal displacement correction amount output from the thermal displacement correction amount calculation unit 121 is updated, and a tool tip point abruptly moves when the updated thermal displacement correction unit is applied as it is, which may cause an adverse effect on the machining, such as generation of machining streaks or the like. Therefore, as shown in FIG. 4, the numerical control device 13 divides the thermal displacement correction amount into each distribution amount, and controls the axis in the machine tool on the basis of the thermal displacement distribution amount obtained by the division. This operation causes the thermal displacement correction amount to be increased little by little by each thermal displacement distribution amount toward a target thermal displacement correction amount, which can reduce the adverse effect on the machining.

Each of the storage unit 133, the machining program analysis unit 134, the distribution amount determination device 135, the correction amount distribution unit 136, and the axis control unit 137 will be described below.

The storage unit 133 stores at least one of information relating to surface quality in machining, information relating to dimensional accuracy in machining, or a machining program.

The information relating to surface quality in machining is, for example, at least one of information relating to a speed during interpolation or information relating to program command curving. The information relating to dimensional accuracy in machining is, for example, at least one of the information relating to a speed during interpolation or the information relating to program command curving. The information relating to a speed during interpolation is information relating to a speed such as acceleration/deceleration before and after the interpolation (acceleration, jerk, corner speed difference, time constant of acceleration/deceleration after interpolation, or the like). The storage unit 133 stores, for example, a preset value of the numerical control device 13, or a value set by a user on an operation screen.

Whether the information relating to a speed during interpolation is the information relating to surface quality in machining or the information relating to dimensional accuracy in machining is determined by, for example, magnitude of each of the acceleration, the corner speed difference, and the time constant of acceleration/deceleration after interpolation, as shown in Table 1.

TABLE 1

| | Set Emphasis on | Set Emphasis on |
|---|---|---|
| Item | Surface Quality | Dimensional Accuracy |
| Acceleration | Small | Small |
| Corner Speed Difference | Small | Small |
| Time Constant of | Large | Small |
| Acceleration/Deceleration | | |
| after Interpolation | | |

For example, in a case where only the information relating to surface quality in machining is stored in the storage unit 133, if the time constant of acceleration/deceleration after interpolation which is the information relating to a speed during interpolation is a certain value or more, the information relating to a speed during interpolation is stored as the information relating to surface quality in machining. On the other hand, if the time constant of acceleration/deceleration after interpolation is less than the certain value, the information relating to a speed during interpolation is regarded as the information relating to dimensional accuracy in machining and is not stored.

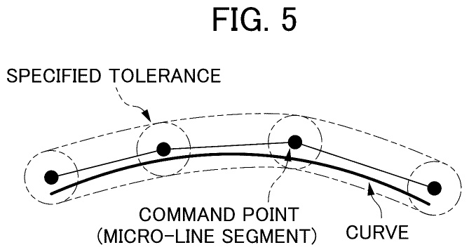

Whether the information relating to program command curving is the information relating to surface quality in machining or the information relating to dimensional accuracy in machining is determined by, for example, magnitude of a tolerance from a path formed by connecting machining command points, as shown in Table 2. FIG. 5 is a diagram showing the tolerance from the path formed by connecting machining command points.

TABLE 2

| | Set Emphasis on | Set Emphasis on |
|---|---|---|
| Item | Surface Quality | Dimensional Accuracy |
| Tolerance from Path | Large | Small |
| Formed by Connecting | | |
| Machining Command | | |
| Points | | |

For example, in a case where only the information relating to surface quality in machining is stored in the storage unit 133, if the tolerance from the command point which is the information relating to program command curving is a certain value or more, the information relating to program command curving is stored as the information relating to surface quality in machining. On the other hand, if the tolerance from the command point is less than the certain value, the information relating to program command curving is regarded as the information relating to dimensional accuracy in machining and is not stored.

The machining program analysis unit 134 reads out a machining program from the storage unit 133, analyzes the machining program, and outputs a machining program analysis result to the distribution amount determination device 135. The machining program analysis result includes information indicating whether the machining program is executing micro-line segment processing, the machining program is executing curve interpolation processing, or the machining program is executing rapid traverse.

The distribution amount determination device 135 reads out at least one (hereinafter, referred to as machining-related information) of the information relating to surface quality in machining or the information relating to dimensional accuracy in machining from the storage unit 133 and/or acquires a machining program analysis result from the machining program analysis unit 134. The distribution amount determination device 135 determines a distribution amount for dividing the thermal displacement correction amount on the basis of the machining-related information and/or the machining program analysis result, and outputs the distribution amount to the correction amount distribution unit 136. A configuration and operation of the distribution amount determination device 135 will be described below in detail.

As shown in FIG. 4, the correction amount distribution unit 136 divides the thermal displacement correction amount output from the thermal displacement correction device 12 into each distribution amount output from the distribution amount determination device 135, and outputs, to the axis control unit 137, the thermal displacement distribution amount obtained by the division.

The axis control unit 137 controls the axis in the machine tool for each control axis on the basis of the thermal displacement distribution amount output from the correction amount distribution unit 136, and corrects the thermal displacement of the tool tip point. The distribution amount determination device 135 will be further described below with reference to FIGS. 1 and 4.

### (Distribution Amount Determination Device 135)

As shown in FIG. 1, the distribution amount determination device 135 includes a condition storage unit 1351, an information acquisition unit 1352 that acquires emphasis information for machining, and a distribution amount determination unit 1353.

The condition storage unit 1351 outputs a condition for determining a distribution amount and the distribution amount to the distribution amount determination unit 1353. Table 3 shows, as one example, distribution amount determination conditions and distribution amounts. In Table 3, conditions (1) and (2) each indicate the condition for a machining program analysis result, conditions (3) to (7) each indicate the condition for the information relating to a speed during interpolation, and conditions (8) to (10) each indicate the condition for the information relating to program command curving.

TABLE 3

| | | Distribution | |
|---|---|---|---|
| Conditions | | Amount | |
| (1) | Micro-line segment is being executed or curve | 1 | μm |
| | interpolation is being executed | | |
| (2) | Rapid traverse is being executed | 10 | μm |
| (3) | Acceleration/deceleration parameter designation for | 1 | μm |
| | index 1 | | |
| (4) | Acceleration/deceleration parameter designation for | 5 | μm |
| | index 2 | | |
| (5) | Acceleration/deceleration parameter designation for | 10 | μm |
| | index 3 | | |
| (6) | Acceleration setting value is 800 mm/sec² or less, | 1 | μm |
| | corner speed difference is 300 mm/min or less, and | | |
| | time constant of acceleration/deceleration after | | |
| | interpolation is 32 msec or more | | |
| (7) | Acceleration setting value is 800 mm/sec² or less, | 10 | μm |
| | corner speed difference is 300 mm/min or less, and | | |
| | time constant of acceleration/deceleration after | | |
| | interpolation is 16 msec or less | | |
| (8) | Tolerance from command point is 10 μm or more | 1 | μm |
| (9) | Tolerance from command point is 5 μm or more and | 5 | μm |
| | less than 10 μm | | |
| (10) | Tolerance from command point is less than 5 μm | 10 | μm |

One example of acceleration/deceleration parameter designation for each of indexes 1, 2, and 3 of the conditions (3), (4), and (5) in Table 3 is shown in Table 4. The index 1 is an acceleration/deceleration parameter for emphasis on surface quality, the index 2 is a standard acceleration/deceleration parameter, and the index 3 is an acceleration/deceleration parameter for emphasis on dimensional accuracy.

TABLE 4

| Index 1 | | Index 3 |
|---|---|---|
| Emphasis on Surface | Index 2 | Emphasis on |
| Quality | Standard | Dimensional Accuracy |
| Acceleration Setting | Acceleration Setting | Acceleration Setting |
| 400 mm/sec² | 800 mm/sec² | 400 mm/sec² |
| Corner Speed | Corner Speed | Corner Speed |
| Difference | Difference | Difference |
| 150 mm/min | 300 mm/min | 150 mm/min |
| Time Constant of | Time Constant of | Time Constant of |
| Acceleration/ | Acceleration/ | Acceleration/ |
| Deceleration | Deceleration | Deceleration |
| after Interpolation | after Interpolation | after Interpolation |
| 32 msec | 16 msec | 16 msec |

The condition for determining a distribution amount and the distribution amount are set in consideration of at least one of the surface quality in machining, the dimensional error, or the machining program analysis result. In a case where emphasis is placed on the surface quality, since when a change in correction amount is too large, a step occurs between adjacent passes in reciprocating cutting of the surface, which forms tooling marks, the distribution amount of the thermal displacement correction amount is reduced so that a better machining result can be obtained. In a case where emphasis is placed on the dimensional accuracy, it is desirable that the distribution amount of the thermal displacement correction amount is large. When the distribution amount is large, a difference between the target correction amount and the output correction amount is reduced, which enables correction with higher accuracy. If the machining program is executing the rapid traverse, the distribution amount is increased This is because in the rapid traverse, the machining is not performed, which does not affect the machining.

The information acquisition unit 1352 reads out at least one (machining-related information) of the information relating to surface quality in machining or the information relating to dimensional accuracy in machining from the storage unit 133, and/or acquires the machining program analysis result from the machining program analysis unit 134 to output, to the distribution amount determination unit 1353, the information including at least one of the machining-related information or the machining program analysis result.

The distribution amount determination unit 1353 determines a distribution amount on the basis of at least one of the information output from the information acquisition unit 1352, namely, at least one of the machining program analysis result, the information relating to a speed during interpolation, or the information relating to program command curving, and on the basis of the condition for determining a distribution amount and the distribution amount that are read out from the condition storage unit 1351. Specifically, the distribution amount determination unit 1353 determines to which of the conditions for determining a distribution amount, at least one of the machining program analysis result, the information relating to a speed during interpolation, or the information relating to program command curving corresponds, and determines the distribution amount associated with the corresponding condition to be distributed.

If there is no corresponding condition, the distribution amount determination unit 1353 selects a preset default distribution amount. Setting the default distribution amount in advance makes it possible for the distribution amount determination unit 1353 to execute a smooth process without stopping a process of determining a distribution amount even when there is no corresponding condition. In a case where there are a plurality of corresponding conditions, the distribution amount determination unit 1353 selects the smallest distribution amount. This can prevent defects such as machining streaks from occurring.

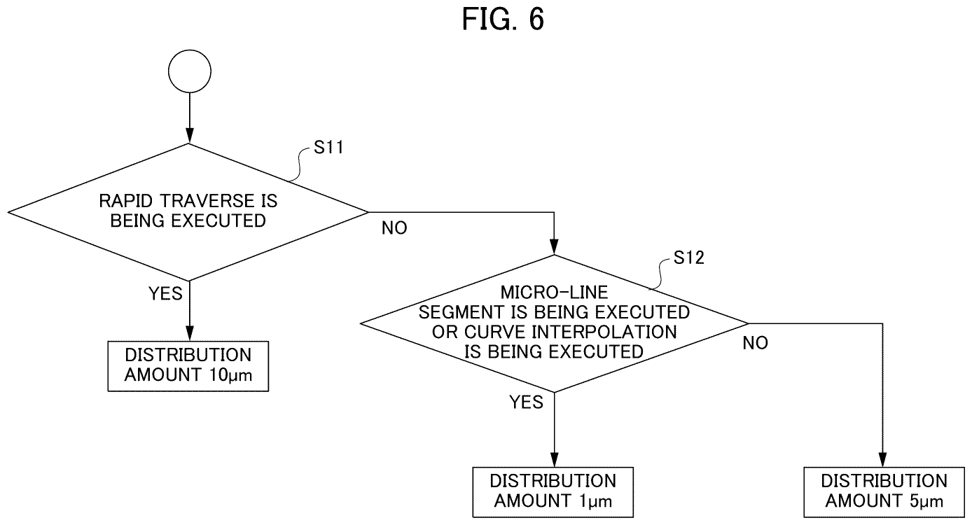

FIG. 6 shows a flow according to which the distribution amount determination unit 1353 determines a distribution amount on the basis of the machining program analysis result. In FIG. 6, in Step S11, the distribution amount determination unit 1353 determines whether the rapid traverse is being executed. If the rapid traverse is being executed (YES), the distribution amount determination unit 1353 determines the distribution amount as 10 μm. If the rapid traverse is not being executed (NO), the process proceeds to Step S12.

In Step S12, the distribution amount determination unit 1353 determines whether the micro-line segment processing is being executed or the curve interpolation processing is being executed, and if the micro-line segment processing is being executed or the curve interpolation processing is being executed (YES), the distribution amount determination unit 1353 determines the distribution amount as 1 μm. If the micro-line segment processing is not being executed or the curve interpolation processing is not being executed (NO), the distribution amount determination unit 1353 determines the distribution amount as 5 μm.

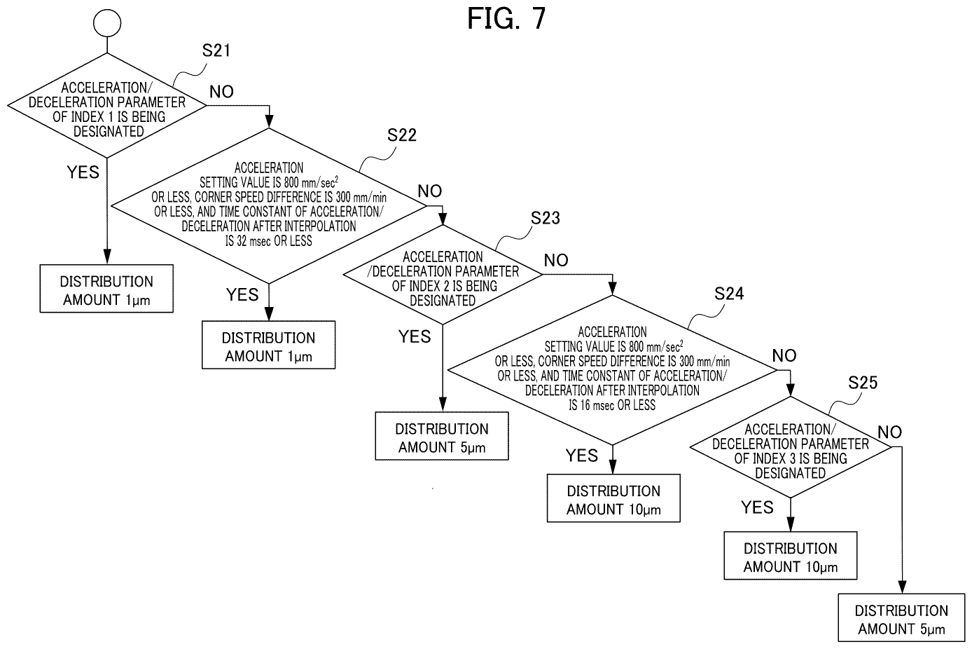

FIG. 7 shows a flow according to which the distribution amount determination unit 1353 determines a distribution amount on the basis of the information relating to a speed during interpolation. In FIG. 7, in Step S21, the distribution amount determination unit 1353 determines whether the acceleration/deceleration parameter of the index 1 is being designated. If the parameter is being designated (YES), the distribution amount determination unit 1353 determines the distribution amount as 1 μm. If the parameter is not being designated (NO), the process proceeds to Step S22.

In Step S22, the distribution amount determination unit 1353 determines whether three conditions that the acceleration setting value is 800 mm/sec² or less, the corner speed difference is 300 mm/min or less, and the time constant of acceleration/deceleration after interpolation is 32 msec or more are satisfied. If the three conditions are satisfied (YES), the distribution amount determination unit 1353 determines the distribution amount as 1 μm. If the three conditions are not satisfied (NO), the process proceeds to Step S23.

In Step S23, the distribution amount determination unit 1353 determines whether the acceleration/deceleration parameter of the index 2 is being designated. If the parameter is being designated (YES), the distribution amount determination unit 1353 determines the distribution amount as 5 μm. If the parameter is not being designated (NO), the process proceeds to Step S24.

In Step S24, the distribution amount determination unit 1353 determines whether three conditions that the acceleration setting value is 800 mm/sec² or less, the corner speed difference is 300 mm/min or less, and the time constant of acceleration/deceleration after interpolation is 16 msec or less are satisfied. If the three conditions are satisfied (YES), the distribution amount determination unit 1353 determines the distribution amount as 10 μm. If the three conditions are not satisfied (NO), the process proceeds to Step S25.

In Step S25, the distribution amount determination unit 1353 determines whether the acceleration/deceleration parameter of the index 3 is being designated. If the parameter is being designated (YES), the distribution amount determination unit 1353 determines the distribution amount as 10 μm. If the parameter is not being designated (NO), the distribution amount determination unit 1353 determines the distribution amount as 5 μm.

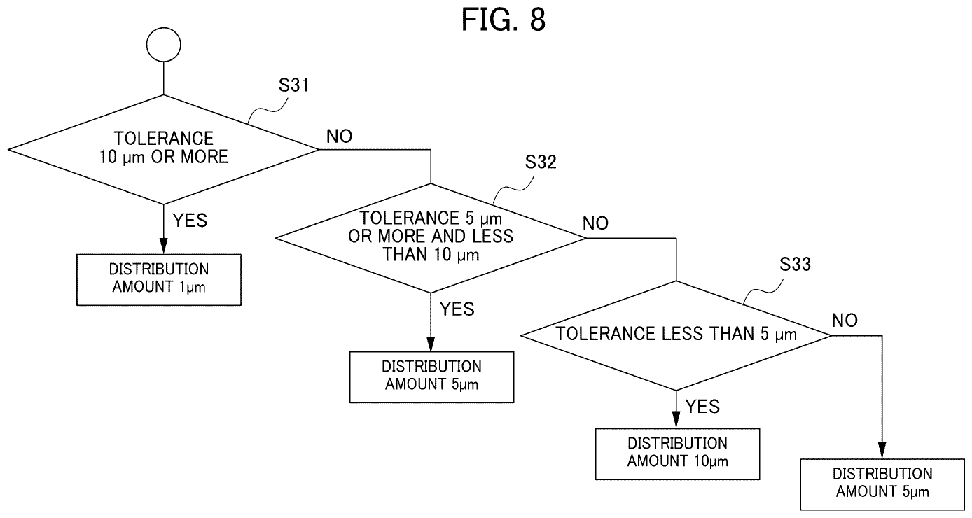

FIG. 8 shows a flow according to which the distribution amount determination unit 1353 determines a distribution amount on the basis of the information relating to program command curving. In FIG. 8, in Step S31, the distribution amount determination unit 1353 determines whether the tolerance from the command point is 10 μm or more. If the tolerance is 10 μm or more (YES), the distribution amount determination unit 1353 determines the distribution amount as 1 μm. If the tolerance is less than 10 μm (NO), the process proceeds to Step S32.

in Step S32, the distribution amount determination unit 1353 determines whether the tolerance from the command point is 5 μm or more and less than 10 μm. If the tolerance is 5 μm or more and less than 10 μm (YES), the distribution amount determination unit 1353 determines the distribution amount as 5 μm. If the tolerance is less than 5 μm and 10 μm or more (NO), the process proceeds to Step S33.

In Step S33, the distribution amount determination unit 1353 determines whether the tolerance from the command point is less than 5 μm. If the tolerance from the command point is less than 5 μm (YES), the distribution amount determination unit 1353 determines the distribution amount as 10 μm. If the tolerance from the command point is 5 μm or more (NO), the distribution amount determination unit 1353 determines the distribution amount as 5 μm.

When the distribution amount determination unit 1353 reduces the distribution amount with emphasis on surface quality, the machining streaks or the like can be prevented from occurring and the surface quality can be improved, whereas when the distribution amount is large, a difference between the target correction value and the distribution amount is reduced, which enables correction with higher accuracy. As such, it is not necessarily easy to determine the distribution amount. In addition, it is time-consuming for a user to determine whether machining is performed with emphasis on surface quality or with emphasis on dimensional accuracy from a machining procedure manual or the like and set the distribution amount for each machining. Therefore, it is desired to provide a distribution amount determination device, a numerical control device, and a distribution amount determination system that can easily determine distribution amounts of a thermal displacement correction amount of a machine tool without inconveniencing a user.

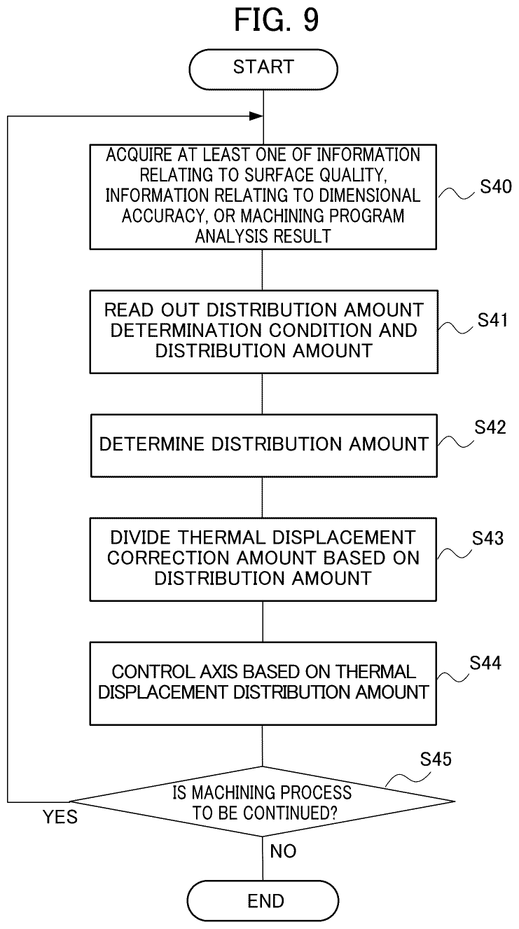

The operation of the numerical control device 13 will be described below using a flowchart. FIG. 9 is the flowchart showing the operation of the numerical control device 13.

In Step S40, the information acquisition unit 1352 acquires at least one of the information relating to surface quality in machining, the information relating to dimensional accuracy in machining, or the machining program analysis result.

In Step S41, the distribution amount determination unit 1353 reads out the condition for determining a distribution amount and the distribution amount from the condition storage unit 1351.

In Step S42, the distribution amount determination unit 1353 determines to which of the conditions for determining a distribution amount, at least one of the machining program analysis result, the information relating to a speed during interpolation, or the information relating to program command curving corresponds, and determines the distribution amount associated with the corresponding condition to be distributed.

In Step S43, the correction amount distribution unit 136 divides the thermal displacement correction amount into each distribution amount and obtains the thermal displacement distribution amount.

In Step S44, the axis control unit 137 controls the axis in the machine tool on the basis of the thermal displacement distribution amount, and corrects the thermal displacement of the tool tip point.

In Step S45, the numerical control device 13 determines whether the machining process is to be continued, and if YES, the process returns to Step S40, or if NO, the process ends.

The components included in the distribution amount determination device or the numerical control device of the embodiment described above can be implemented by hardware, software or a combination of hardware and software. Here, being implemented by software means being implemented by a computer reading and executing a program. In order to implement the components included in the distribution amount determination device or the numerical control device by software or a combination of hardware and software, the distribution amount determination device or the numerical control device includes a processor such as a central processing unit (CPU). The processor functions as the execution unit. The distribution amount determination device or the numerical control device may include a plurality of processors operating in parallel. The distribution amount determination device or the numerical control device also includes an auxiliary storage device such as a hard disk drive (HDD) that stores various programs such as application software or an operating system (OS), and a main storage device such as a random memory (RAM), which stores the program required by the processor to execute the functions and operations in FIG. 9 of the distribution amount determination device or the numerical control device as described in FIG. 1, and data temporarily required on the program. The distribution amount determination device or the numerical control device may include a plurality of main storage devices.

In the distribution amount determination device or the numerical control device, the processor reads the application software or OS from the auxiliary storage device, loads the read application software or OS into the main storage device, and executes computing processing based on the application software or OS. Various hardware components included in the distribution amount determination device or the numerical control device are controlled on the basis of the computation results. In this manner, the functional blocks of the present embodiment are implemented.

The components included in the distribution amount determination device or the numerical control device can also be implemented by hardware such as an electronic circuit. When the distribution amount determination device or the numerical control device is configured by hardware, some or all of the functions of the components included in the distribution amount determination device or the numerical control device may be configured by an integrated circuit (IC) such as an application specific integrated circuit (ASIC), a gate array, a field programmable gate array (FPGA), or complex programmable logic device (CPLD).

Programs can be stored and supplied to a computer using various types of non-transitory computer readable media. Non-transitory computer readable media include various types of tangible storage media. Examples of non-transitory computer readable media include magnetic storage media (for example, hard disk drives), magneto-optical storage media (for example, magneto-optical disks), CD-ROMs (read only memory), CD-Rs, CD-R/Ws, and semiconductor memory (for example, mask ROMS, programmable ROMS (PROMs) erasable PROMs (EPROMs), flash ROMs, and random access memory (RAM)). Programs may also be supplied to the computer using various types of transitory computer readable media.

The effect of the distribution amount determination device in the above-described embodiment is that the distribution amounts of the thermal displacement correction amount of the machine tool can be easily determined without inconveniencing a user. The numerical control device and the distribution amount determination system for a thermal displacement correction amount can divide a thermal displacement correction amount into each distribution amount using the distribution amount determination device, and control the axis in the machine tool on the basis of the thermal displacement distribution amount obtained by the division.

Although the present disclosure has been described, the present disclosure is not limited to the individual embodiments described above. Various additions, replacements, modifications, partial deletions, and the like can be made to the embodiments without departing from the scope of the present disclosure, as derived from the content of the claims and their equivalents. The embodiments may also be implemented in combination. For example, the order of operations and the sequence of processing described as examples in the above-described embodiments, and are not limited thereto.

The following further discloses additional remarks regarding the foregoing embodiment.

### (Additional Remark 1)

A distribution amount determination device (135) that determines a distribution amount of a thermal displacement correction amount of a machine tool includes: an in-machining emphasis information acquisition unit (1352) that acquires information including at least one of information relating to surface quality in machining, information relating to dimensional accuracy in machining, or a machining program analysis result; a condition storage unit (1351) that stores at least one condition of a condition for emphasis on surface quality, a condition for emphasis on dimensional accuracy, or a condition for a machining program analysis result, and stores a distribution amount when the at least one condition is satisfied; and a distribution amount determination unit (1353) that determines a distribution amount of the thermal displacement correction amount, based on the information including the at least one acquired by the in-machining emphasis information acquisition unit, and based on the at least one condition and the distribution amount when the condition is satisfied, the at least one condition and the distribution amount being stored in the condition storage unit.

### (Additional Remark 2)

In the distribution amount determination device as described in Additional Remark 1, the information relating to surface quality in machining includes at least one of information relating to a speed during interpolation or information relating to program command curving, and the information relating to dimensional accuracy in machining includes at least one of information relating to a speed during interpolation or information relating to program command curving.

### (Additional Remark 3)

In the distribution amount determination device as described in Additional Remark 1, in a case where the information including the at least one and acquired by the in-machining emphasis information acquisition unit does not correspond to the at least one condition stored in the condition storage unit, the distribution amount determination unit (1353) selects a preset distribution amount.

### (Additional Remark 4)

In the distribution amount determination device as described in Additional Remark 1, in a case where the information including the at least one and acquired by the in-machining emphasis information acquisition unit corresponds to a plurality of conditions stored in the condition storage unit, the distribution amount determination unit (1353) selects a smallest distribution amount from among a plurality of distribution amounts corresponding to the plurality of conditions

### (Additional Remark 5)

A numerical control device (13) including: the distribution amount determination device (135) as described in any one of Additional Remarks 1 to 4; and a correction amount distribution unit (136) that distributes a thermal displacement correction amount of a machine tool, based on the distribution amount determined by the distribution amount determination unit of the distribution amount determination device.

### (Additional Remark 6)

A distribution amount determination system for a thermal displacement correction amount includes: the numerical control device (136) as described in Additional Remark 5; and a thermal displacement correction device (12) that generates a thermal displacement correction amount of a machine tool based on temperature data regarding the machine tool, and outputs the thermal displacement correction amount to the numerical control device.

### EXPLANATION OF REFERENCE NUMERALS

10 Distribution amount determination system
11 Temperature sensor
12 Thermal displacement correction device
13 Numerical control device
121 Thermal displacement correction amount calculation unit
131 Temperature acquisition unit
132 Temperature data saving unit
133 Storage unit
134 Machining program analysis unit
135 Distribution amount determination device
136 Correction amount distribution unit
137 Axis control unit
1351 Condition storage unit
1352 In-machining Emphasis information acquisition unit
1353 Distribution amount determination unit

1. A distribution amount determination device that determines a distribution amount of a thermal displacement correction amount of a machine tool, the distribution amount determination device comprising:
an in-machining emphasis information acquisition unit that acquires information including at least one of information relating to surface quality in machining, information relating to dimensional accuracy in machining, or a machining program analysis result;
a condition storage unit that stores at least one condition of a condition for emphasis on surface quality, a condition for emphasis on dimensional accuracy, or a condition for a machining program analysis result, and stores a distribution amount when the at least one condition is satisfied; and
a distribution amount determination unit that determines a distribution amount of the thermal displacement correction amount based on the information including the at least one and acquired by the in-machining emphasis information acquisition unit, and based on the at least one condition and the distribution amount when the condition is satisfied, the at least one condition and the distribution amount being stored in the condition storage unit.

2. The distribution amount determination device according to claim 1, wherein
the information relating to surface quality in machining includes at least one of information relating to a speed during interpolation or information relating to program command curving, and
the information relating to dimensional accuracy in machining includes at least one of information relating to a speed during interpolation or information relating to program command curving.

3. The distribution amount determination device according to claim 1, wherein
in a case where the information including the at least one and acquired by the in-machining emphasis information acquisition unit does not correspond to the at least one condition stored in the condition storage unit, the distribution amount determination unit selects a preset distribution amount.

4. The distribution amount determination device according to claim 1, wherein
in a case where the information including the at least one and acquired by the in-machining emphasis information acquisition unit corresponds to a plurality of conditions stored in the condition storage unit, the distribution amount determination unit selects a smallest distribution amount from among a plurality of distribution amounts corresponding to the plurality of conditions.

5. A numerical control device, comprising:
the distribution amount determination device according to claim 1; and
a correction amount distribution unit that distributes a thermal displacement correction amount of a machine tool based on the distribution amount determined by the distribution amount determination unit of the distribution amount determination device.

6. A distribution amount determination system for a thermal displacement correction amount, comprising:
the numerical control device according to claim 5; and
a thermal displacement correction device that generates a thermal displacement correction amount of a machine tool based on temperature data regarding the machine tool, and outputs the thermal displacement correction amount to the numerical control device.
